(19) United States
(12) Patent Application Publication
(10) Pub. No.: US 2012/0205466 A1
(43) Pub. Date: Aug. 16, 2012

(54) AEROSOL SPRAY NOZZLE

(75) Inventors: James Paul Baltz, Waterville, OH (US); Jessica Rose Bryant, Toledo, OH (US)

(73) Assignee: Illinois Tool Works Inc., Glenview, IL (US)

(21) Appl. No.: 13/357,607

(22) Filed: Jan. 24, 2012

Related U.S. Application Data
(60) Provisional application No. 61/442,671, filed on Feb. 14, 2011.

(51) Int. Cl. B05B 1/26

(52) U.S. Cl. 239/461

(57) ABSTRACT

A system is provided that includes an aerosol atomization assembly or insert. The aerosol atomization assembly or insert includes a fluid atomization path, a pre-orifice disposed along the fluid atomization path and configured to restrict a fluid flow of fluid along the fluid atomization path, and a mechanical break-up unit disposed along the fluid path and configured to create turbulence in the fluid flow, wherein the pre-orifice and the mechanical break-up unit are integrated into a single piece.

### CROSS-REFERENCE TO RELATED APPLICATIONS

This application claims the benefit of U.S. Provisional Patent Application Ser. No. 61/442,671 entitled “AEROSOL SPRAY NOZZLE,” filed on Feb. 14, 2011, which is herein incorporated by reference in its entirety for all purposes.

### FIELD OF THE INVENTION

The present disclosure relates generally to an aerosol spray nozzle and, more specifically, to a system for the atomization and particulate breakup of a fluid emitted from an aerosol can.

### BACKGROUND

Aerosol spray coating systems often have a low transfer efficiency. That is, a large portion of a sprayed coating material may not actually coat a target object. Rather, much of the sprayed coating material may be lost to the surrounding atmosphere, may coat an object that is not intended to be coated, and/or may inadvertently wrap around and deposit on a user, for example the user's hand or clothing. As an example, when a metal fence is sprayed with an aerosol spray paint can, only a small portion of the paint may actually be deposited on the fence, with a large portion of the paint being wasted due to the spray pattern that is inherent to many aerosol nozzles. Further, liquid coating materials often include globules, particulates, or ligaments, which result in uneven coatings on a target object, and thus an undesirable finish.

### SUMMARY

Various embodiments of the present disclosure provide a system having an atomization insert configured to mount within a spray nozzle of a self-contained aerosol charged fluid spray can. The atomization insert includes a fluid atomization path, a pre-orifice disposed along the fluid atomization path, and a mechanical break-up unit disposed along the fluid atomization path. The pre-orifice is configured to restrict a fluid flow of fluid along the fluid atomization path. The mechanical break-up unit is configured to increase turbulence in the fluid flow, and the atomization insert is a one-piece structure having the fluid atomization path, the pre-orifice, and the mechanical break-up unit.

In one embodiment, a system has an aerosol spray nozzle configured to couple to a self-contained aerosol charged fluid spray can. The nozzle includes a fluid path, a first receptacle disposed along the fluid path, wherein the first receptacle is configured to receive a fluid outlet of the self-contained aerosol charged fluid spray can, and a second receptacle disposed along the fluid path. The system also includes a one-piece atomization insert having a pre-orifice and a mechanical break-up unit, wherein the atomization insert is configured to be inserted into the second receptacle.

In another embodiment, a system has a spray device with a frame having a spray can receptacle and a spray nozzle opening. The spray can receptacle is configured to receive a self-contained aerosol charged fluid spray can. The system also includes a spray nozzle having first and second sections extending crosswise relative to one another, wherein the first section is configured to couple to a fluid outlet of the self-contained aerosol charged fluid spray can, and the second section is configured to extend through the spray nozzle opening to an offset distance from the frame. The system further includes a trigger coupled to the frame, and the trigger is configured to actuate the spray nozzle.

These and other features, aspects, and advantages of the present disclosure will become better understood when the following detailed description is read with reference to the accompanying drawings in which like characters represent like parts throughout the drawings.

### BRIEF DESCRIPTION OF THE DRAWINGS

FIG. 1 is a diagram illustrating an electrostatic spray coating system in accordance with one embodiment of the present disclosure;

FIG. 2 is a perspective view of an embodiment of a spray device for use in the spray coating system illustrated in FIG. 1;

FIG. 3 is a side view of the spray device illustrated in FIG. 2, with a side panel removed to expose a trigger assembly;

FIG. 4 is a cross-sectional side view of the spray device of FIG. 3 taken within line 4-4 of FIG. 3, illustrating an embodiment of a nozzle assembly having a direct charging electrode and a mechanical break up unit with an integrated pre-orifice;

FIG. 5 is an exploded cross-sectional side view of the nozzle assembly of FIG. 4,

FIG. 6 is an exploded side cross-sectional side view taken within line 6-6 of FIG. 5, illustrating the mechanical break up unit and the forward portion of the nozzle exploded from one another; and

FIG. 7 is a cross-sectional side view taken within line 7-7 of FIG. 4, illustrating the mechanical break up unit in an installed position with respect to the nozzle.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Various embodiments of the present disclosure provide a spray device that includes a nozzle assembly configured to cause a spray that is discharged to encounter a pre-orifice and a mechanical break up unit (referred to herein as an “MBU”), both of which may be integrated into a single piece that is disposed proximate an outlet of the nozzle assembly. In some embodiments, the pre-orifice and the mechanical break up unit include chambers that are configured to restrict fluid flow out of the nozzle assembly and to create turbulence in the fluid flow, both of which may provide enhanced atomization efficiency. The nozzle assembly also passes the discharged fluid over a charging electrode (e.g., via direct charging), or by passing the discharged fluid through an ion field after atomization (e.g., via indirect charging), which causes the discharged fluid from the spray can to become electrostatically charged.

A spray nozzle of the nozzle assembly includes at least a first section and a second section, at least one of which may protrude out of a frame of a spray device in which the nozzle is disposed. Such protrusion may mitigate wrap-around (e.g., onto a user's hand or the spray device) of a discharged spray.

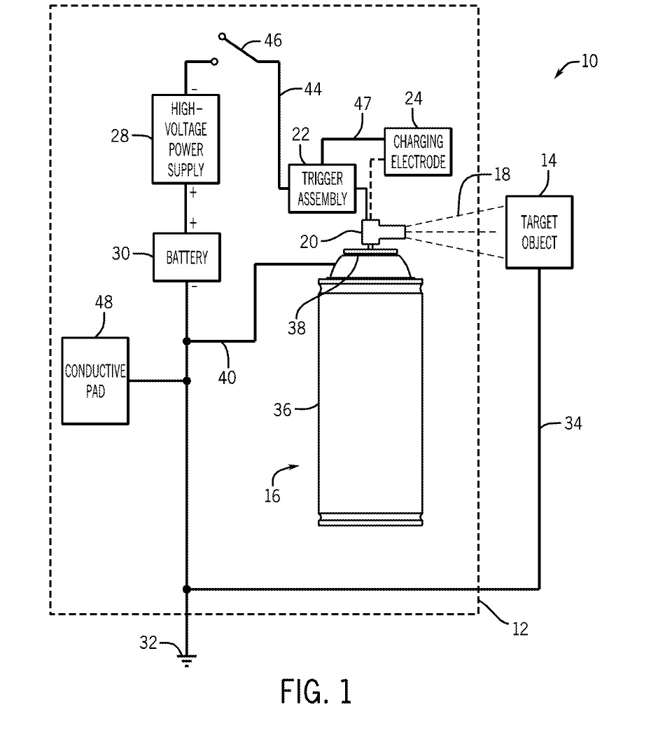

Referring now to FIG. 1, a diagrammatical representation of an example embodiment of a spray coating system 10 is illustrated. The spray coating system 10 illustrated in FIG. 1 includes a spray device 12 for applying a desired coating to a target object 14. In the illustrated embodiment, the spray device 12 includes a self-contained spray can 16 configured to provide a spray of fluid 18 toward the target object 14. As will be appreciated, the self-contained spray can 16 may include a liquid coating, such as paint, and a pressurized gas or propellant. For example, the self-contained spray can 16 may be a self-contained aerosol charged paint spray can. The aerosol generally pressurizes the spray can 16, and when the spray can 16 is activated (i.e., a valve is opened), a portion of the aerosol is released, which propels the coating. In the illustrated embodiment, the spray can 16 interfaces with a nozzle assembly 20, which may include various features for charging and/or atomizing fluid discharged from the spray can 16. As mentioned above and as will be discussed in further detail below, the nozzle assembly 20 includes a one-piece insert having a pre-orifice and an MBU. When the nozzle assembly 20 is depressed, a valve of the spray can 16 opens, thereby facilitating a flow of fluid through the nozzle assembly 20 to produce the spray of fluid 18, which includes a fine mist of coating droplets. Specifically, the pressure exerted by the propellant (e.g., aerosol) on the liquid facilitates the breakup of the liquid as the liquid flows through the nozzle assembly 20. As droplets impact the target object 14, the target object 14 is coated with the liquid. In certain embodiments, the liquid is a paint which forms a coating on the target object 14 as the paint dries.

To allow a user to selectively produce the spray of fluid 18, the spray device 12 includes a trigger assembly 22. The trigger assembly 22 is generally configured to engage the nozzle assembly 20 to cause the fluid to be discharged from the self-contained spray can 16. In addition, the spray device 12 includes a charging device, such as a charging electrode 24, to electrostatically charge the spray of fluid 18. Specifically, the charging electrode 24 imparts an electrostatic charge on the fluid droplets prior to or after atomization, depending on the placement of the charging electrode 24. As a consequence of having a static charge, the droplets may be electrostatically attracted to an electrically grounded object, such as the target object 14, thereby increasing the transfer efficiency between the fluid and the target object 14. Unfortunately, because the spray device 12 is also grounded in accordance with certain embodiments, as noted above, a portion of the electrostatically charged spray of fluid 18 may also be attracted to a user holding the spray device 12, and/or to the device itself. Accordingly, the nozzle assembly 20, as noted above, extends a certain distance out of the spray device 12 to mitigate such wrap around of the spray of fluid 18.

In one embodiment, the spray coating system 10 includes a direct charging system, wherein the charging electrode 24 is a direct charging electrode. In the direct charging system, as the fluid discharged from the spray can 16 passes over the charging electrode 24, the fluid directly accepts a charge (e.g., a negative charge). The fluid is then atomized in the nozzle assembly 20 after receiving the charge by the charged electrode 24. In other embodiments, the spray coating system 10 includes an indirect charging system in which the charging electrode 24 is an indirect charging electrode. In the indirect charging system, the fluid is atomized in the nozzle assembly 20 and then the individual fluid particles pass through an ion field, thereby causing each fluid particle to obtain a charge. For example, the present embodiments may be used in conjunction with the charging systems described in U.S. patent application Ser. No. 12/954,525 by Bryant et al. entitled “Electrostatic Spray System with Grounding Teeth,” filed Nov. 24, 2010, and U.S. patent application Ser. No. 12/714,280 by Seitz et al. entitled “Electrostatic Spray System,” filed Feb. 26, 2010, both of which are incorporated by reference herein in their entirety for all purposes. Accordingly, embodiments of the system 10 may employ a variety of indirect or direct charging devices (e.g., electromagnetic transducers) to impart an electrostatic charge of the fluid droplets.

As illustrated, the charging electrode 24 is electrically coupled to a high-voltage power supply 28, which supplies a high-voltage signal to the electrode 24. For example, in certain embodiments, the high-voltage power supply 28 may provide more than approximately 5 k, 7.5 k, 9 k, 10.5 k, 15 k, 20 k, 25 k, 30 k, 35 k volts, or more to the charging electrode 24. While a high-voltage signal is provided, a relatively small electrical current may be sufficient to impart the desired charge on the fluid droplets. For example, the high-voltage power supply 28 may be configured to output less than approximately 100, 80, 60, 50, 40, 30, or less micro-Amperes. As illustrated, a positive terminal of a battery 30 is electrically coupled to a positive terminal of the high-voltage power supply 28. Based on the desired power output from the high-voltage power supply 28, a commercially available battery (e.g., 9V, 12V, etc.) may be employed to provide electrical power to the high-voltage power supply 28. In various alternative embodiments, a standard or proprietary rechargeable battery may be employed.

In the illustrated embodiment, the negative terminal of the battery 30 is electrically coupled to an earth ground 32. For example, a suitable earth ground 32 may be established by driving a conductive stake into soil. In such a configuration, an electrical charge flowing into the stake may be dissipated through the soil. Alternatively, the earth ground 32 may include an electrical connection to a conductive water pipe or main having a subterranean portion. The subterranean portion of the conductive pipe serves to dissipate an electrical charge into the soil in a similar manner to the stake described above. The earth ground 32 may also include an electrical connection to a building ground (e.g., the ground plug of an electrical outlet).

As illustrated, an electrical conductor 34 extends between the target object 14 and the earth ground 32. Consequently, the potential of the target object 14 will be substantially equal to the potential of the earth ground 32. As a result, the potential difference or voltage between the electrostatically charged fluid droplets and the target object 14 may be greater than configurations in which the target object 14 is connected to a chassis ground of the spray device 12. For example, if the potential of the chassis of the spray device 12 is greater than the potential of the earth, the potential difference between the charged fluid droplets and the target object 14 may be reduced. The target object 14 is electrically coupled to the earth ground 32, and, thus, the transfer efficiency of the fluid spray 18 is enhanced due to the increased potential difference.

In addition, the self-contained spray can 16 is electrically coupled to the earth ground 32. As illustrated, the spray can 16 includes a body 36 and a neck 38. The body 36 and neck 38 may be composed of a conductive material, such as aluminum or steel. In the present embodiment, an electrical conductor 40 extends between the spray can 16 and the earth ground 32. As a result, the spray can 16 is electrically grounded to the earth ground 32.

The high-voltage power supply 28 may be activated after both a positive and negative electrical connection is established with the battery 30. In the illustrated embodiment, the negative electrical connection with the battery 30 includes the electrical conductor 40 and the self-contained spray can 16. The negative electrical connection between the high-voltage power supply 28 and the battery 30 is interrupted when the spray can 16 is removed from the spray device 12. Consequently, the high-voltage power supply 28 may not activate unless the spray can 16 is present within the spray device 12 and the electrical conductor 40 is in contact with the spray can 16.

In the illustrated embodiment, an electrical conductor 44 connects a switch 46 with the trigger assembly 22. The switch 46 is configured to selectively activate the charging electrode 24 when the trigger assembly 22 is triggered, for example by providing a charge through an electrical connect 47 between the trigger assembly 22 and the charging electrode 24. The switch 46 blocks current flow from the high-voltage power supply 28 while in the illustrated open position, and enables current flow from the high-voltage power supply 28 while in the closed position. In alternative embodiments, the switch 46 may be positioned between the positive terminal of the battery 30 and the positive terminal of the high-voltage power supply 28. In the illustrated embodiment, the switch 46 is positioned adjacent to the trigger assembly 22, such that depression of the trigger closes the switch 46. In this manner, the spray of fluid 18 is initiated at substantially the same time as activation of the charging electrode 24.

The spray device 12 also includes a conductive pad 48 coupled to the earth ground 32. As discussed in detail below, the conductive pad 48 may be attached to a handle of the spray device 12 such that an operator's hand makes contact with the pad 48 while the operator grasps the spray device 12. The conductive pad 48 is electrically connected to the earth ground 32, such that the potential of the operator is substantially equal to the earth potential while the operator is grasping the spray device 12.

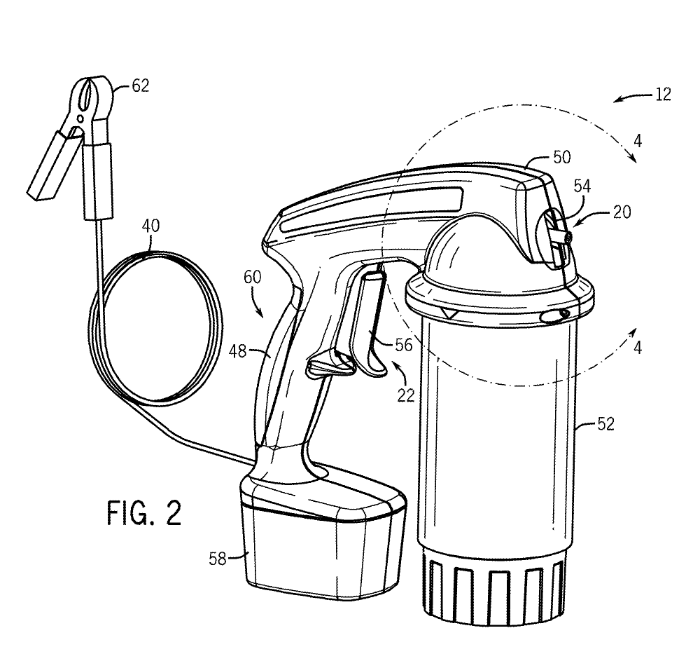

Referring now to FIG. 2, an exemplary spray device for use in the spray coating system 10 of FIG. 1 is shown. As illustrated, the spray device 12 includes a frame 50 and a removable spray can housing 52. The spray can housing 52 is configured to contain and properly position the self-contained spray can 16 within the spray device 12. To couple the spray can 16 to the spray device 12, the spray can housing 52 may be uncoupled from the frame 50, the spray can 16 may be inserted into the housing 52, and the housing 52 may be re-coupled to the frame 50. Once the spray can 16 is coupled to the spray device 12, the fluid spray 18 may be expelled from the nozzle assembly 20, which extends at least partially through an opening 54 of the frame 50 to mitigate wrap around of the spray 18, as noted above. For example, an operator may depress a trigger 56, thereby inducing the trigger assembly 22 to activate the nozzle assembly 20 of the self-contained spray can 16. As previously discussed, the trigger assembly 22 may be coupled to the electrostatic activation switch 46, such that depressing the trigger 56 activates the charging electrode 24. In this manner, depressing the trigger 56 induces the spray of electrostatically charged fluid 18 to be expelled from the nozzle assembly 20 toward the target object 14 by actuating the nozzle assembly 20.

The spray device 12 also includes a power module 58 coupled to a handle portion 60 of the frame 50. In certain embodiments, the power module 58 contains the battery 30 (FIG. 1) and the high-voltage power supply 28 (FIG. 1). The power module 58 may be removable, such that the battery 30 may be replaced. The handle portion 60 also includes the conductive pad 48 configured to contact an operator hand during operation of the spray device 12. The conductive pad 48 is located in the handle portion 60, such that the operator contacts the pad 48 while grasping the handle portion 60. The electrical conductor 40 extends from the frame 50 of the spray device 10 proximate the handle portion 60, and ends in a spring contact 62, which may be utilized to ground the spray device 10 with the earth ground 32 as described above.

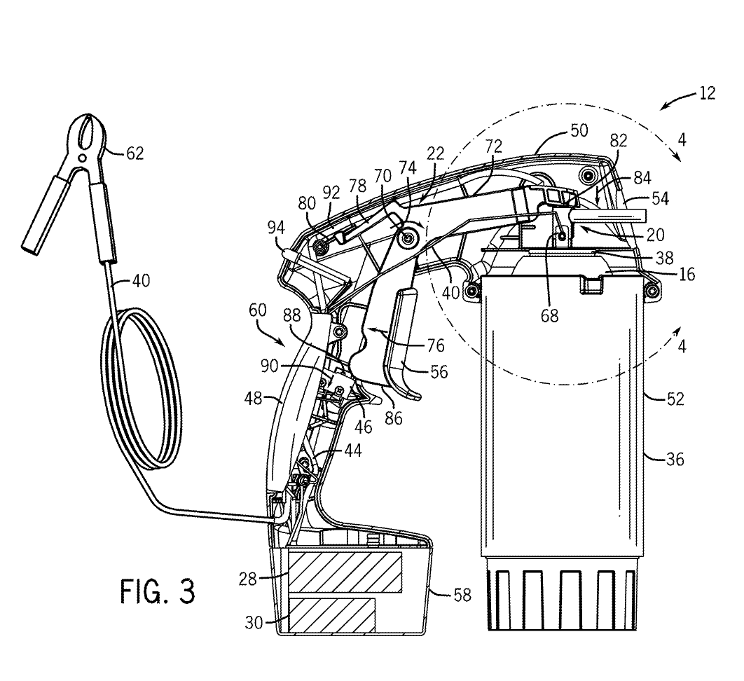

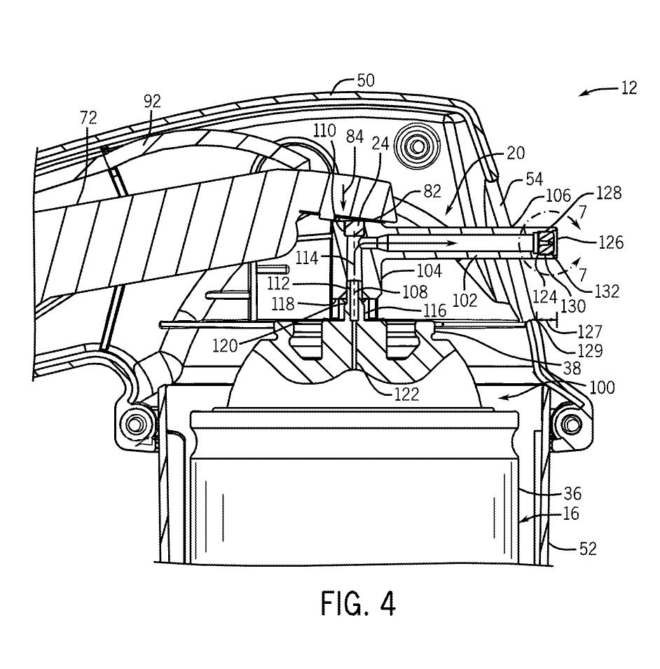

Referring now to FIG. 3, the example spray device 12 of FIG. 2 is shown with a side panel removed to expose the trigger assembly 22. FIG. 3 also illustrates various electrical features contained within the spray device 12. The electrical features include those used to maintain a ground between the spray can 16 and the earth ground 32, as well as the electrical pathway from the high voltage source 28 to the charging electrode 24 (see FIG. 4) disposed within the nozzle assembly 20. Specifically, in the illustrated embodiment, the electrical conductor 40 extends from the spring clip 62, through the internal portion of the frame 50 of the spray device 12, and to an electrical interface tab 68 secured to the spray can 16 (e.g., the neck of the spray can 16). The electrical interface tab 68 provides an electrical interface between the conductor 40 and spring clip 62 (i.e., the earth ground 32) and the spray can 16, which allows the spray can 16 to remain grounded to the earth while the spring clip 62 is secured to a ground, as discussed above. Accordingly, the electrical interface tab 68 may be secured to the spray can 16 via one or more electrically conductive features, such as a spring, bolts, conductive adhesives, welding, brazing, or a compressive fit.

As previously discussed, the trigger assembly 22 may actuate the nozzle assembly 20 to initiate the spray of fluid 18. Additionally, the trigger assembly 22 may enable an electrical pathway to be formed between the high voltage source 28 and the charging electrode 24 (see FIG. 4) to electrostatically charge the droplets that are discharged from the can 16. In the illustrated embodiment, the trigger assembly 22 includes the trigger 56, a pivot 70 and an actuating arm 72. As illustrated, the pivot 70 is coupled to the frame 50 such that the trigger assembly 22 may rotate in a first rotational direction 74 when the trigger 56 is displaced in a direction 76. The trigger assembly 22 also includes a biasing member 78 in contact with a protrusion 80 of the frame 50, which provides a spring force resisting rotation. Such resistance may be desirable to enable a user to easily adjust the rate at which the spray 18 is ejected from the device 12. For example, to initiate the spray of fluid 18, the trigger 56 may be depressed in the direction 76, thereby driving the trigger assembly 22 to rotate about the pivot 70 in the first rotational direction 74. As the trigger assembly 22 rotates, contact between the biasing member 78 and the protrusion 80 induces the biasing member 78 to flex, thereby providing the resistance. In addition, rotation of the trigger assembly 22 induces a contact surface 82 of the distal end of the actuating arm 72 to translate in a direction 84. The contact surface 82 is positioned adjacent to the nozzle assembly 20, such that movement of the contact surface 82 in the direction 84 drives the nozzle assembly 20 toward the neck 38 of the spray can 16, thereby initiating the spray of fluid 18. Moreover, in certain embodiments, the contact surface 82 may be electrically connected to the high voltage power source 28, as will be discussed below. As illustrated, the charging electrode 24 (see FIG. 4) partially extends out of the nozzle assembly 20, such that the contact surface 82 contacts the charging electrode 24 and imparts a charge to the charging electrode 24. This allows the charging electrode 24 to electrostatically charge fluid flowing through from the spray can 16.

As noted above, in the illustrated embodiment, the trigger assembly 22 is configured to activate the charging electrode 24 at substantially the same time as the spray of fluid 18 is initiated. Specifically, the trigger 56 includes a bottom portion 86 positioned adjacent to the electrostatic activation switch 46. As the trigger 56 is depressed in the direction 76, the bottom portion 86 of the trigger 56 contacts a spring-loaded protrusion 88, and drives the protrusion 88 in the direction 90, thereby closing the switch 46. Closing the switch 46 establishes an electrical connection between the high-voltage power supply 28 and the contact surface 82, which allows the charging electrode 24 to be activated. Consequently, depressing the trigger 56 will produce a spray of electrostatically charged fluid droplets from the nozzle assembly 20. Alternative embodiments may position the switch 46 adjacent to other regions (e.g., actuating arm 72, pivot 70, etc.) of the trigger assembly 22, such that depressing the trigger 56 drives the switch 46 to the closed position. In further embodiments, the switch 46 may be operated independently of the trigger 56, such that an operator may initiate the spray of fluid 18 without activating the electrostatic charging.

As illustrated, a conduit 92 having the electrical connection 44 mentioned above with respect to FIG. 1 extends between the high-voltage power supply 28 and the charging electrode 24. As will be appreciated, electrical conductors carrying a high-voltage signal may interfere with surrounding electronic devices and/or induce a charge within adjacent conductors or circuits. Consequently, the conduit 92 is configured to shield surrounding devices, conductors and/or circuits from the high-voltage signal passing through the charging electrode supply conductor. The present embodiment also includes an indicator 94, such as a light emitting diode (LED), which visually depicts the operational state of the electrostatic charging system. As discussed in detail below, the indicator 94 is electrically coupled to the battery 30, and configured to provide a user-perceivable indication (e.g., illuminate) upon activation of the charging electrode 24. Such a visual indicator may enable an operator to readily determine whether the spray of fluid 18 is being electrostatically charged by the spray device 12.

Referring now to FIG. 4, a cross-sectional view taken within line 4-4 of FIG. 3 is illustrated. Specifically, a cross-sectional view of the nozzle assembly 20, an upper section 100 of the spray can 16, and a portion of the trigger assembly 22 is illustrated. As noted above, the trigger assembly 22 may be actuated by movement of the trigger 56 in the direction 76 (FIG. 3). The actuation of the trigger assembly 22 results in the movement of the contact surface 82 in the direction 84. When the contact surface 82 moves in the direction 84 to meet the charging electrode 24, the conduit 92 provides an electrical charge to the contact surface 82, which in turn provides the electrical charge to the charging electrode 24. The electrically charged electrode 24 then, in accordance with the illustrated embodiment, directly contacts fluid discharged from the spray can 16 to impart an electrostatic charge to the fluid.

The downward movement (i.e., in the direction 84) of the contact surface 82 toward the nozzle assembly 20, as noted above, causes the fluid to be discharged from the spray can 16. The nozzle assembly 20 includes a nozzle 102 having a first section (e.g., a vertical section) 104 and a second section 106 (e.g., a horizontal section) extending from the first section 104 in a direction crosswise to an axis 108 of the first section 104. As Thus, the sections 104 and 106 may be angled with respect to one another by between approximately 10 degrees and 90 degrees, such as by approximately 10, 20, 30, 40, 50, 60, 70, 80, or 90 degrees with respect to one another. In some embodiments, the first and second sections 104, 106 define a substantially L-shaped geometry of the nozzle 102. The first section 104 includes a pair of receptacles, a first receptacle 110 and a second receptacle 112 disposed at opposite longitudinal extents of the first section 104.

The first receptacle 110 is configured to receive at least a portion of the charging electrode 24, and is disposed at an extent of the first section 104 proximate the contact surface 82 of the trigger assembly 22. In this way, the first receptacle 110 is able to position the charging electrode 24 proximate the contact surface 82, such that when the trigger assembly 22 is triggered, the contact surface 82 contacts the charging electrode 24 to provide an electrical charge. The first receptacle 110 may be shaped so as to conform to the shape of the charging electrode 24. For example, the first receptacle 110 may have an annular shape so as to provide a relatively secure fit for the charging electrode 24, which may also have an annular shape. It should be appreciated that, in various embodiments, the first receptacle 110 may have a square, rectangular, circular, triangular, or other suitable geometry, depending on the geometry of the charging electrode 24. Moreover, the first receptacle 110, while positioning the charging electrode 24 proximate the contact surface 82, may also position the charging electrode 24 proximate to and/or along a flow path 114 of the fluid that is discharged from the spray can 16. This allows the charging electrode 24, when electrically charged, to impart an electrostatic charge directly onto the discharged fluid.

The second receptacle 112 of the first section 104, as noted above, is disposed at the opposite longitudinal extent of the first section 104 from the first receptacle 110. The second receptacle 112 is generally configured to receive an outlet 116 of the spray can 116, such that the fluid that is discharged from the can 16 is received into the first section 104 along the flow path 114. The second receptacle 112 may be sized so as to conform to the geometry of the outlet 116 of the spray can 16. Thus, the second receptacle 112, in some embodiments, may have a conical, frusto-conical, cylindrical, or annular shape that is configured to receive the outlet 116 of the spray can 16. Moreover, the second receptacle 112 may be configured to receive a variety of shapes and/or sizes of the outlet 116, such that the nozzle assembly 20 may be used in conjunction with a variety of different spray cans 16 and/or spray devices 12. The second receptacle 112 also includes an area of the nozzle assembly 20 that is used as an abutment surface 118. The abutment surface 118 is configured to contact a flared surface 120 of the outlet 116. When depressed in towards the body 36 of the spray can 16, the flared surface 120 causes an outlet valve of the spray can 16 to open to release the aerosol contained within the spray can 16. Thus, when the trigger assembly 20 is activated, the nozzle assembly 20 moves toward the spray can 16, which causes the abutment surface 118 to meet the flared surface 120 of the outlet 116. The contact between the abutment surface 118 and the flared surface 120 causes fluid to flow through an internal conduit 122 of the spray can 16 leading to the outlet 116. This causes the fluid to be discharged into the first section 104 along the axis 108.

Once the fluid is discharged from the can 16 into the first section 104 and gains an electrostatic charge from the charging electrode 24, the fluid flows along the flow path 114 and into the second section 106 of the nozzle 102. As noted above, the second section 106 extends from the first section 104 in a substantially crosswise manner with respect to the axis 108. The second section 106 includes a third receptacle 124 proximate an outlet 126 of the nozzle 102. The outlet 126 is generally configured to output the spray 18, and, as mentioned above, is at an area of the nozzle 102 that extends out of the opening 54 of the frame 50 at least by an offset distance 127 from an outermost extent 129 of the opening 54. The distance 127 may at least partially prevent the electrostatically charged spray 18 from wrapping around and depositing on the spray device 12 or a user's hand. For example, as the distance 127 increases, the likelihood that the spray 18 may wrap around onto the device 12 and/or the user's hand may decrease, as the electrostatic forces that cause such wraparound may diminish with increasing separation between the charged spray and a ground (i.e., the device 12). The third receptacle 124 is configured to receive and house an atomization insert 128.

The atomization insert 128 includes a pre-orifice 130 and MBU 132, which are each integrated into the atomization insert 128 as a single piece. The single piece may be formed by attaching together separate pieces, or molding a single piece. The configuration of the atomization insert 128 is discussed in further detail below.

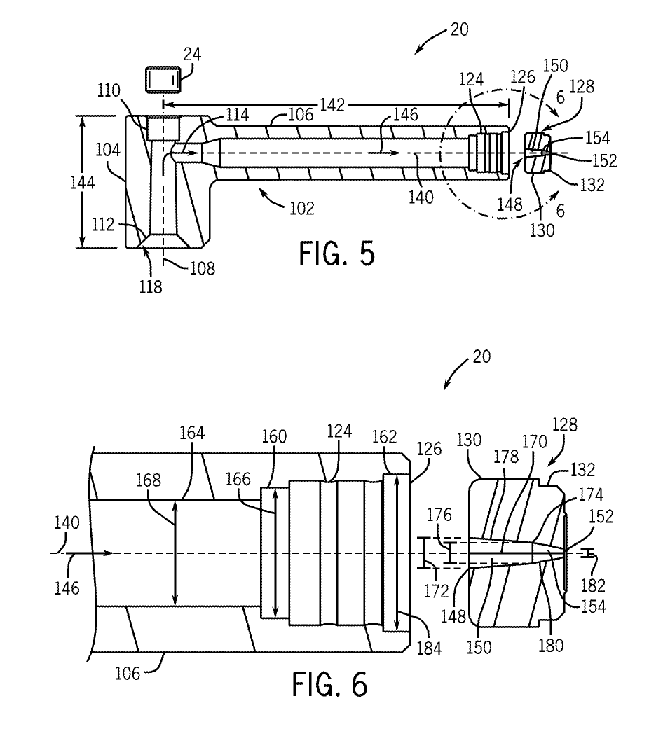

FIG. 5 is an exploded cross-sectional side view of the nozzle assembly 20. As illustrated in FIG. 5, the charging electrode 24 and the atomization insert 128 are shown as exploded away from the nozzle 102 along their respective connection axes. In the illustrated embodiment, the first receptacle 110 has a generally cylindrical interior shape that matches the generally cylindrical exterior shape of the charging electrode 24, and enables the conductive electrode 24 to extend beyond the extent of the nozzle 102. The second receptacle 112, which as noted above is disposed along the axis 108 at an opposite extent of the first section 104, has a frusto-conical shape that allows the outlet 116 of the spray can 16 to be received while allowing the abutment surface 118, which is a tapered surface, to contact the flared surface 120 of the outlet 116 of the spray can 16. As noted above, the flow path 114 flows the fluid that is discharged from the spray can 16 through the first section 104, over at least a portion of the charged electrode 24, and into the second section 106 of the nozzle 102. The second section 106 has a fluid flow axis 140 that flows the fluid along the second section 106 and to the atomization insert 128, which is illustrated as exploded from the third receptacle 124 along the fluid flow axis 140.

The second section 106, as noted above, has a length 142, such that the outlet 126 extends out of the opening 56 of the frame 50 to the offset distance 127 from the frame 50. Indeed, in some embodiments, the ratio of the length 142 of the second section 106 to a length 144 of the first section 102 may be at least about 1.1:1. For example, the ratio may be approximately 1.1:1, 1.2:1, 1.3:1, 1.4:1, 1.5:1, 1.6:1, 1.7:1, 1.8:1, 1.9:1, 2.0:1, 2.1:1, 2.2:1, 2.3:1, 2.4:1, 2.5:1, 2.6:1, 2.7:1, 2.8:1, 2.9:1, 3:1 or more. Moreover, the total exterior lengths of each of the sections may have a similar or the same ratio as those mentioned above.

The second section 106 includes the third receptacle 124, which is configured to receive and house the atomization insert 128. As noted above, the atomization insert 128 includes the pre-orifice 130 and MBU 132. The pre-orifice 130 is generally configured to restrict the flow of a charged fluid, depicted as arrow 146, that enters into the atomization insert 128. The pre-orifice 130 includes an inlet 148 that leads to a first conical passage 150. The first conical passage 150 has a geometry that converges to an outlet 152 disposed at an opposite latitudinal extent of the assembly 128 from the inlet 148. The first conical passage 150, which defines the pre-orifice 130, leads to a second conical passage 154, which defines the MBU 132. The MBU 132, in a general sense, is configured to create turbulence in the flow of the charged fluid 146, and leads to the outlet 152.

FIG. 6 is a cross-sectional side view taken within line 6-6 of FIG. 5. As illustrated in FIG. 6, the second section 106 is depicted as having the third receptacle 124 bounded by a pair of fluid expansion regions, such as a first expansion region 160 (e.g., annular expansion region) and a second expansion region 162 (e.g., annular expansion region). The first expansion region 160 is disposed along the fluid path 114 upstream of the third receptacle 124, which causes the charged fluid 146 to expand upon exiting a main conduit 164 of the second section 106. The first expansion region 160 causes the charged fluid 146 to expand radially to a diameter 166 that is larger than a diameter 168 of the main conduit 164. As an example, diameter 166 of the expansion region 160 may be approximately 10%, 20%, 30%, 40%, 50% larger or more than the diameter 168 of the main conduit 164. In some embodiments, the expansion that occurs within such regions may cause/include turbulence, mixing, and fluid breakup.

As the fluid passes through the first expansion region 160, it encounters the atomization insert 128, which includes a plurality of annular regions having decreasing diameters along a fluid atomization path 170. In the illustrated embodiment, the atomization insert 128 includes the inlet 148, which has a diameter 172 that is substantially reduced compared to the diameter 166 of the first expansion region 160. For example, the diameter 172 of the inlet 148 may be between approximately 1% to 50% the size of the diameter 166 of the first expansion region 160 e.g., 10%, 20%, 30%, 40%, 50%, 60%, 70%, 80% or 90%). The diameter 172 of the inlet 148 may be varied to meter the amount of fluid that is atomized and ejected from the nozzle assembly 20. In this regard, the pre-orifice 130 of the atomization insert 128 also serves to meter the amount of fluid that exits the spray device 12. Moreover, the abrupt diameter changes mentioned above and described further below may help to induce mixing, turbulence, breakup of fluids, densification, expansion, and so forth.

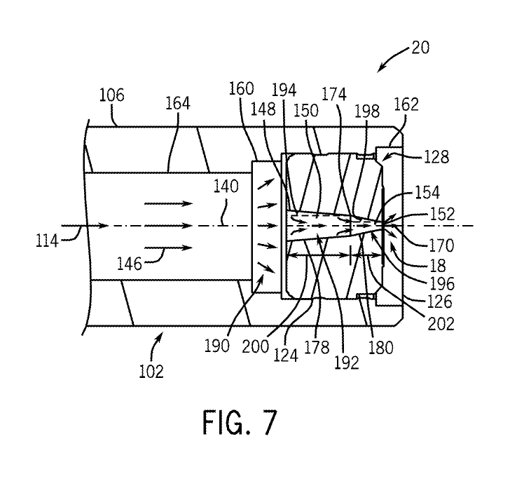

Along the fluid atomization path 170, the atomization insert 128 includes the pre-orifice 130, which is defined by the inlet 148 and the first conical passage 150. The first conical passage 150 tapers into a first inflection region 174. The first inflection region 174 has a diameter 176 that is smaller than the diameter 172 of the inlet 148, and is the inlet of the MBU 132 portion of the atomization insert 128. As an example, the ratio of the diameter 172 of the inlet 148 to the diameter 176 of the first inflection region 174 may be between approximately 1.1:1 and approximately 4:1, such as approximately 1.1:1, 1.2:1, 1.3:1, 1.4:1, 1.5:1, 2.0:1, 2.5:1, 3.0:1, 3.5:1, 4.1:1, or more. In one embodiment, the ratio may be approximately 1.3:1. The first inflection region 174, as will be appreciated with reference to the illustrated embodiment, is the region at which a first tapered surface 178 forming the first conical passage 150 and having a first taper (e.g. angle) inflects into a second tapered surface 180 forming the second conical passage 154 and having a second taper (e.g., angle), as will be discussed in further detail with respect to FIG. 7. The second conical passage 154, as noted above, converges towards the outlet 152, which has a diameter 182 that is smaller than the diameter 176 and the diameter 172. As an example, the ratio of the diameter 172 of the inlet 148 to the diameter 182 of the outlet 152 may be between approximately 1.1:1 and approximately 4:1, such as 1.1:1, 1.2:1, 1.3:1, 1.4:1, 1.5:1, 2.0:1, 2.5:1, 3.0:1, 3.5:1, 4.0:1, or more. In one embodiment, the ratio of the diameter 172 to diameter 182 may be approximately 2.0:1. The ratio of the diameter 176 of the first inflection region 174 to the diameter 182 of the outlet 152 may be between approximately 1.1:1 and approximately 3:1, such as 1.1:1, 1.2:1, 1.3:1, 1.4:1, 1.5:1, 2.0:1, 2.5:1, 3.0:1, 3.5:1, 4.0:1, or more. In one embodiment, the ratio of the diameter 176 to the diameter 182 may be approximately 1.5:1.

As noted above, the second expansion region 162 is disposed on the opposite extent of the atomization insert 128 from the first expansion region 160. The second expansion region 162 may allow the fluid that has traversed the atomization insert 128 to expand and create the electrostatic spray 18. As an example, the second expansion region 162 may have a diameter 184 that is larger than the diameter 182 of the outlet 152. In embodiments, the diameter 184 of the second expansion region 162 may be smaller, substantially the same, or larger than the diameter 166 of the first expansion region 160. As an example, the diameter 184 of the second expansion region 162 may be approximately 10%, 20%, 30%, 40%, 50%, 60% larger or more than the diameter 166 of the first expansion region 160. The ratio of the diameter 184 of the second expansion region 162 to the diameter 182 of the outlet 152 may be between approximately 2.0:1 and approximately 20:1, such as 2.0:1, 3.0:1, 4.0:1, 5.0:1, 10:1, 15:1, 20:1, or more, or any ratio therebetween. In one embodiment, the ratio of the diameter 184 to the diameter 182 may be approximately 10:1.

Moving now to FIG. 7, a cross-sectional side view taken within line 7-7 of FIG. 4 is illustrated. In particular, the atomization insert 128 is illustrated as disposed within the third receptacle 124 of the second section 106 of the nozzle 102. The manner in which the charged fluid 146 expands, contracts, and re-expands upon flowing along the fluid atomization path 170 is also illustrated. As the charged fluid 146 flows along the fluid path 114, the fluid 146 encounters the first expansion region 160, of the fluid atomization path 170. The charged fluid 146 may then experience any one or a combination of turbulence, mixing, expansion, or fluid breakup as represented by arrows 190. The resulting fluid then encounters the inlet 148 of the atomization insert 128 (i.e., the pre-orifice 130), and the flow of the first expanded fluid 190 is restricted by the diameter 172 of the inlet 148. The inlet 148 may be configured to meter the fluid flow, while also increasing turbulence, mixing, and breakup of the fluid. As the fluid 190 enters and progresses through the pre-orifice 130, the fluid 190 accelerates and, in some cases, becomes increasingly dense, represented generally as arrows 192. This process is generally due to the tapered surface 178, which defines the first conical passage 150. The taper of the tapered surface 178 may be defined by an angle 194, such as approximately 1° to 15°, from the fluid flow axis 140.

As the fluid 192 moves through the pre-orifice 130 and encounters the inflection region 174 (i.e., the MBU 132), the fluid 192 experiences increasing turbulence and/or densification, represented generally as arrows 196. The increased turbulence may result from the presence of the inflection region 174, and the increased densification may result from the second tapered surface 180 defining the second conical passage 154. The taper of the second tapered surface 180 is defined by an angle 198, such as approximately 1° to 25°, from the fluid flow axis 140. In certain embodiments, the angle 194 and the angle 198 may be different, with the angle 198 being larger, for example by between 0.1 and 10 degrees. In this manner, the second conical passage 154 converges towards the outlet 152 at a steeper angle (i.e., at a faster rate).

As the charged fluid 146 flows through the atomization insert 128, the fluid 146 gains potential energy, which is released as the fluid 196 exits the outlet 152. For example, the fluid gains potential energy due to the process that occurs by way of the tapered surfaces 178, 180, which causes droplets having a similar or the same electrostatic charge to be placed in close proximity to one another. The densification increases the potential energy of the densified fluid by creating higher levels of electrostatic repulsion. Moreover, such densification increases the pressure of the fluid relative to the atmospheric pressure outside of the outlet 152 by simple fluid dynamics. Thus, in some embodiments, the ratio of a length 200 of the pre-orifice 130 to a length 202 of the MBU 132 may at least partially affect the fluid flow dynamics and the potential energy of the fluid as it flows through the atomization insert 128. As an example, the ratio of the length 198 to the length 200 may be between approximately 0.5:1.0 and 2.0 to 1.0. In some embodiments, the ratio of the length 198 to the length 200 may be approximately 0.5:1, 0.6:1, 0.7:1, 0.8:1, 0.9:1, 1:1, 1.1:1, 1.2:1, 1.3:1, 1.4:1, 1.5:1, 1.6:1, 1.7:1, 1.8:1, 1.9:1 or 2.0:1. Upon reaching the outlet 152, the fluid 196 encounters the second expansion region 162, which, due to the diameter 184 noted above, enables the turbulent fluid 196 to release the stored potential energy gained by flowing through the atomization insert 128. The expansion that results may also aid in producing the electrostatic coating spray 18 described above. Moreover, the second expansion region 162 may help further atomize and/or control the shape of the spray 18.

It should also be understood that the various examples disclosed herein may have features that can be combined with those of other examples or embodiments disclosed herein. That is, the present examples are presented in such as way as to simplify explanation but may also be combined one with another. The patentable scope of the present disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
an atomization insert configured to mount within a spray nozzle of a self-contained aerosol charged fluid spray can, the atomization insert comprising a one-piece structure having: (i) a fluid atomization path, (ii) a pre-orifice disposed along the fluid atomization path, the pre-orifice being configured to restrict a fluid flow of fluid along the fluid atomization path, and (iii) a mechanical break-up unit disposed along the fluid atomization path, the mechanical break-up being configured to increase turbulence in the fluid flow.

2. The system of claim 1, wherein the atomization insert comprises a fluid outlet and the pre-orifice comprises a first conical passage converging towards the fluid outlet.

3. The system of claim 2, wherein the first conical passage comprises a first inlet having a first diameter, the first conical passage converges into an inflection region having a second diameter smaller than the first diameter, and the second diameter defines a second inlet of a second conical passage of the mechanical break-up unit.

4. The system of claim 3, wherein a ratio of the first diameter to the second diameter is at least approximately 1.1:1.

5. The system of claim 3, wherein the second conical passage converges into the fluid outlet, and the fluid outlet has a third diameter smaller than the first and second diameters.

6. The system of claim 5, wherein a ratio of the first diameter to the third diameter is at least approximately 1.2:1.

7. The system of claim 5, wherein a ratio of the second diameter to the third diameter is at least approximately 1.1:1

8. The system of claim 3, wherein the first conical passage comprises a first tapered surface oriented at a first angle with respect to a fluid flow axis of the fluid atomization path, and the second conical passage comprises a second tapered surface oriented at a second angle with respect to the fluid flow axis, and the first angle is smaller than the second angle.

9. The system of claim 1, comprising the spray nozzle having a fluid path, wherein the spray nozzle comprises a first receptacle disposed along the fluid path, and the first receptacle is configured to receive the atomization insert.

10. The system of claim 9, wherein the spray nozzle comprises a second receptacle configured to couple a fluid outlet of the self-contained aerosol charged fluid spray can with the fluid path, and a third receptacle configured to support a charging electrode along the fluid path.

11. The system of claim 10, wherein the first section comprises a first portion of the fluid path having the second and third receptacles, the second section comprises a second portion of the fluid path having the first receptacle, and the first and second portions of the fluid path are crosswise to one another.

12. The system of claim 11, wherein the first section has a first axis, the second section has a second axis, the first and second axes are crosswise to one another, and the second section protrudes away from the first section.

13. A system, comprising:
an aerosol spray nozzle configured to couple to a self-contained aerosol charged fluid spray can, the aerosol spray nozzle comprising:
a fluid path;
a first receptacle disposed along the fluid path, wherein the first receptacle is configured to receive a fluid outlet of the self-contained aerosol charged fluid spray can; and
a second receptacle disposed along the fluid path; and
a one-piece atomization insert having a pre-orifice and a mechanical break-up unit, wherein the atomization insert is configured to be inserted into the second receptacle.

14. The system of claim 13, wherein the one-piece atomization insert is removable with respect to the aerosol spray nozzle, the pre-orifice is configured to restrict a fluid flow of a fluid along the fluid path, and the mechanical break-up unit is configured to increase turbulence in the fluid flow.

15. The system of claim 13, wherein the first receptacle is configured to coaxially align with the self-contained aerosol charged fluid spray can along a first section of the fluid path, the second receptacle is disposed along a second section of the fluid path, the first section of the fluid path has a first fluid flow axis that is crosswise relative to a second fluid flow axis of the second section of the fluid path, and the second section is at least approximately 10% longer than the first section.

16. The system of claim 15, wherein the first and second sections define an L-shaped geometry of the aerosol spray nozzle.

17. The system of claim 16, wherein the first section comprises a third receptacle disposed along the fluid path, and the third receptacle is configured to support a charging electrode along the fluid path.

18. A system, comprising:
a spray device, comprising:
a frame having a spray can receptacle and a spray nozzle opening, wherein the spray can receptacle is configured to receive a self-contained aerosol charged fluid spray can;
a spray nozzle comprising first and second sections extending crosswise relative to one another, wherein the first section is configured to couple to a fluid outlet of the self-contained aerosol charged fluid spray can, and the second section is configured to extend through the spray nozzle opening to an offset distance from the frame; and
a trigger coupled to the frame, wherein the trigger is configured to actuate the spray nozzle.

19. The system of claim 18, wherein the spray nozzle comprises a charging electrode.

20. The system of claim 18, wherein the spray nozzle comprises a removable atomization insert having a pre-orifice and a mechanical break-up unit integrated into a single piece.
